(19) United States
(12) Patent Application Publication
(10) Pub. No.: US 2026/0212723 A1
(43) Pub. Date: Jul. 23, 2026

(54) ROULETTE GAMING APPARATUS WITH INTERACTIVE DEFLECTOR FEATURE

(71) Applicant: LNW Gaming, Inc., Las Vegas, NV (US)

(72) Inventors: Aljosa KRUPENKO, Jesenice (SI); Joseph Randolph HEDRICK, Reno, NV (US); Dougal AUSTIN, Reno, NV (US)

(21) Appl. No.: 19/456,879

(22) Filed: Jan. 22, 2026

Related U.S. Application Data
(60) Provisional application No. 63/747,626, filed on Jan. 21, 2025.

(51) Int. Cl. G07F 17/32; G07F 17/34

(52) U.S. Cl. CPC G07F 17/3213; G07F 17/3209; G07F 17/322; G07F 17/3286; G07F 17/34

(57) ABSTRACT

A method and/or system is described herein to perform operations associated with a gaming system that utilizes a roulette wheel. In one example, the roulette wheel includes a ball track configured to receive, in connection with a roulette game, a released ball, which traverses the ball track prior to settling into a numbered segment of the roulette wheel. At least a portion of the ball track includes a deflector and a sensor associated with the deflector. The system can detect, via the sensor while the ball traverses the ball track, an interaction event associated with the deflector (e.g., detection of a ball-to-deflector interaction). The system can further, in response to detection of the interaction event, present an effect (e.g., animate a highlight effect via a presentation device, present a highlight effect via a deflector element, etc.).

### CROSS-REFERENCE TO RELATED APPLICATIONS

This application claims the priority benefit of U.S. Provisional Patent Application No. 63/747,626 filed Jan. 21, 2025, which 63/747,626 application is incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2026, LNW Gaming, Inc.

### FIELD

The present disclosure relates generally to gaming systems, apparatus, and methods and, more particularly, to presentation and control of roulette devices, including via animations, highlighting and/or effects associated with gaming system features.

### BACKGROUND

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

Roulette is a well-known casino game which has been played for many years. A typical conventional roulette game includes a table bearing a felt covering upon which indicia forming a betting layout has been silk-screened or otherwise imprinted. A typical roulette wheel includes a wheel head with a ring of numbered segments bearing number values (or number indicia) “1” through “36”). The ring of numbered segments (also called numbered pockets) each include a recessed portion, or “pocket,” into which a roulette ball can come to rest as an outcome for the roulette game. The betting layout has individual betting spots that correspond to (and indicate) the number values. In addition to the number values “1” through “36,” the number ring (and corresponding betting layout) typically includes one or more additional number values (or number indicia) such as “0,” “00,” “000,” some combination thereof, etc. For example, a first version of roulette (called the “European” version) includes only the single “0” value on the roulette wheel and the betting layout whereas another version (called the “American” version) includes both the “0” and the “00” on the roulette wheel and the betting layout. Typically, for the American version, the “0” and the “00” are disposed at diametrically opposite locations on the number ring of the roulette wheel. The numbers values “1” through “36” are not disposed in numerical order, but are typically disposed in a predetermined arrangement based on the version of roulette being played. For example, the predetermined arrangement of the number values on the roulette wheel varies placement between the American version and the European version. The betting layouts may also appear different for the different versions of the game.

Furthermore, both the roulette wheel segments and/or betting spots on the betting layout that correspond to the number values typically bear the alternating colors of red and black, with the exception of the “0” and “00” number values, whose wheel segments and/or betting spots are typically colored green. In addition, a typical roulette wheel includes a circular, inclined ball track, disposed above, and radially outwardly of the number ring.

In operation of a typical roulette game, players place chips or tokens on the betting layout located on the roulette table, and then the dealer (referred to as a “croupier” in roulette) spins the roulette wheel and then places the ball in motion about the circular ball track. As the roulette wheel slows, the ball moves radially inwardly, traversing a ball track, and comes to rest in one of the pockets associated with a particular one of the numbers of the number ring. After the ball comes to rest in one of the pockets, the croupier or dealer settles the various wagers placed on the table layout in accordance with predetermined rules and wager odds.

The ball track includes deflectors. Deflectors are small diamond-shaped (or oval) obstacles (often made of metal) which are positioned on a lower ball track of the roulette wheel. They also have many other names: diamonds, pins, slats, stops, and disruptors. They are typically equally and symmetrically located around the lower ball track, forming vertical and horizontal barriers individually. Many modern roulette wheels have eight deflectors, whereas some older wheels have 16 deflectors. These little obstacles are designed to make the ball's movement more unpredictable. After the ball is released, the ball traverses the lower ball track containing the deflectors and then enters the rotor falling into a numbered pocket.

A significant technical challenge with some games, including roulette, is to provide new and improved functionality of a gaming device that presents a game of roulette, for example, to provide an improved level of game play that uses new or improved gaming apparatus and/or animations. Animations represent improvements to the underlying technology or technical field of gaming apparatus and, at the same time, have the effect of encouraging prolonged and frequent player participation.

### SUMMARY

According to one embodiment of the present disclosure, a method and/or system is described herein to perform operations associated with a roulette wheel. In one example, the roulette wheel includes a bowl and a wheel head. The bowl includes a ball track having a set of deflectors. The bowl is configured to receive a released roulette ball, which ball traverses the ball track prior to settling into one of a plurality of numbered segments of the wheel head as an outcome of the roulette game. In one example, a sensor is associated with at least one deflector of the set of deflectors. In one example, a processor is configured to execute instructions, which when executed, cause the system to perform operations to detect, via the sensor while the ball traverses the ball track, an interaction event associated with the at least one deflector, and present, in response to detection of the interaction event, an effect (e.g., a highlight effect in connection with presentation of the roulette game).

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming system 100 configured for implementation with a virtual croupier according to at least some aspects of the disclosed concepts.

FIG. 2 is a schematic block diagram of a gaming system architecture 200 according to at least some aspects of the disclosed concepts.

FIG. 3 is an exploded-view diagram of an example roulette wheel 300 according to at least some aspects of the disclosed concepts.

FIG. 4 is a flowchart 400 for controlling roulette interactive deflector features according to at least some aspects of the disclosed concepts.

FIG. 5 is a diagram of a roulette gaming system 500 with interactive deflector features according to at least some aspects of the disclosed concepts.

FIG. 6 is a diagram of a roulette gaming system 600 having interactive deflector features according to at least some aspects of the disclosed concepts.

FIG. 7 is a diagram of a roulette gaming system 700 having interactive deflector features according to at least some aspects of the disclosed concepts.

FIG. 8 is a schematic block diagram of a gaming system 1300 for implementing embodiments in accordance with at least some aspects of the disclosed concepts.

FIG. 9 is a block diagram of a computer 1400 for acting as a gaming system for implementing embodiments according to at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

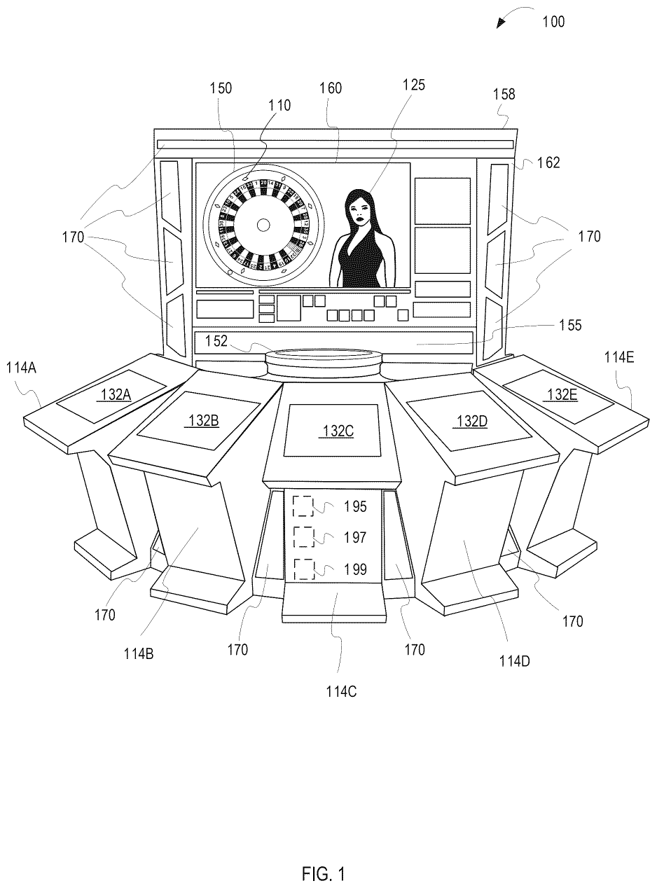

FIG. 1 is a perspective view of a gaming system 100 configured for implementation with a virtual croupier 125 according to at least some aspects of the disclosed concepts. One example of a gaming system 100 similar to one or more gaming systems described in U.S. patent application Ser. No. 17/948,755, filed Sep. 20, 2022 (i.e., the “Ser. No. 17/948,755 application”), in U.S. patent application Ser. No. 17/948,633, filed Sep. 20, 2022 (i.e., the “Ser. No. 17/948,633 application”), or in U.S. patent application Ser. No. 18/483,840 filed Oct. 10, 2023 (i.e., the “Ser. No. 18/483,840” application), which Ser. No. 17/948,755 application, Ser. No. 17/948,633 application, and Ser. No. 18/483,840 application are each incorporated by reference herein in their respective entireties. All patent applications, patents, and printed publications cited herein are incorporated herein by reference in the entireties, except to the extent that the incorporated material is inconsistent with the express disclosure herein, in which case the language in this disclosure controls.

The gaming system 100 includes player terminals 114A through 114E that are arranged in a bank around a video device 158. The video device 158 includes a screen 160. The screen 160 can be used to present a video simulation of a croupier (e.g., virtual croupier 125) for interaction with the video device 158, such as through processing one or more programs stored in a memory 195 to implement the rules of game play at the video device 158. The screen 160 may be carried by a generally vertically extending cabinet 162 of the video device 158. The screen 160 (or in some embodiments, a separate screen) is also configured to display virtual roulette wheel 150 (e.g., a digitally rendered roulette wheel, a reproduction of a digital or physical roulette wheel presented in roulette wheel apparatus 152, a live video stream of a physical roulette wheel, etc.). The virtual roulette wheel 150 responds to operations for (e.g., initiated by, in response to operations that control, etc.) the virtual croupier 125.

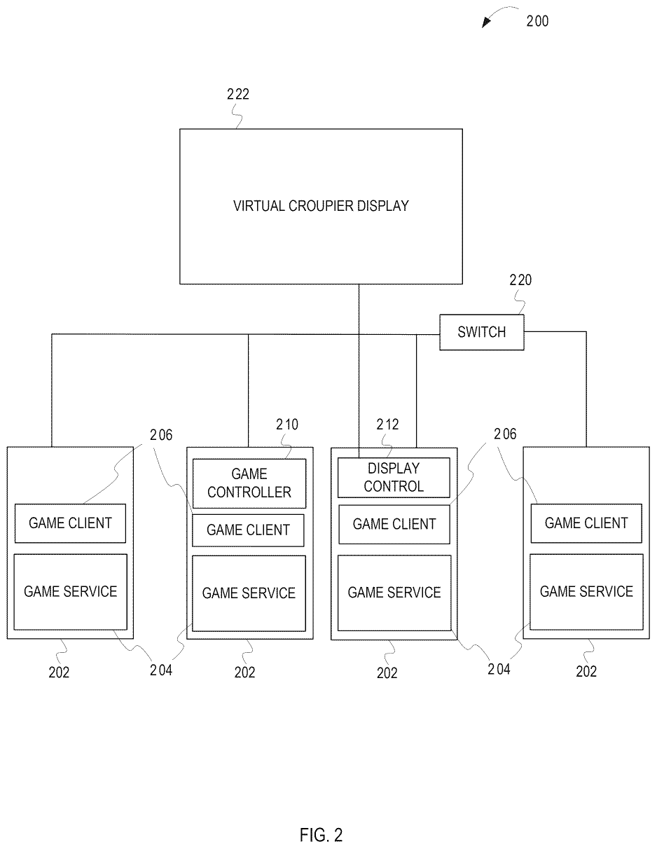

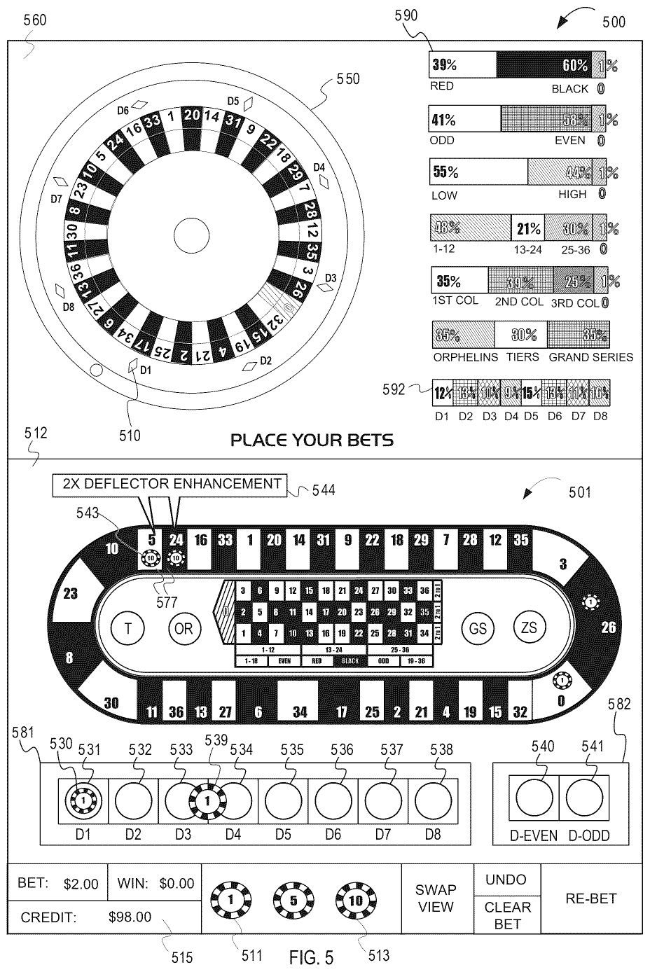

Each of the player terminals 114A through 114E includes a respective player interface area 132A through 132E that is configured for wagering and game play interactions with the video device 158 and/or virtual croupier 125. In some embodiments, the player interface area 132A through 132E can present (depending on a display mode) either one of a user interface (e.g., see user interface 512 in FIG. 5) or a display (e.g., see display 560 in FIG. 5). Furthermore, in some embodiments, all or more of the portion (and/or content) of the display can be presented via the video device 158. Accordingly, at least in some embodiments, game play may be accommodated without involving a physical roulette wheel, physical chips, and/or live personnel. The action may instead be simulated by a control processor 197 interacting with and controlling the video device 158. The control processor 197 may be located internally within, or otherwise proximate to, the video device 158, such as in one of the player terminals 114A through 114E. The control processor 197 may be programmed to implement the rules of game play at the video device 158. As such, in some embodiments, the control processor 197 interacts and communicates with display/input interfaces and data entry inputs for each player interface area 132A through 132E of the respective player terminals 114A through 114E. Other embodiments of gaming systems and gaming devices may include a control processor that may be similarly adapted to the specific configuration of its associated device. In some examples herein, the control processor 197 is referred to as a game controller (e.g., game controller 210). Furthermore, in some examples, the player terminals 114A through 114E can vary in number or location. For example, any of the player terminals 114A through 114E may be any one of the player terminals 202 described in FIG. 2.

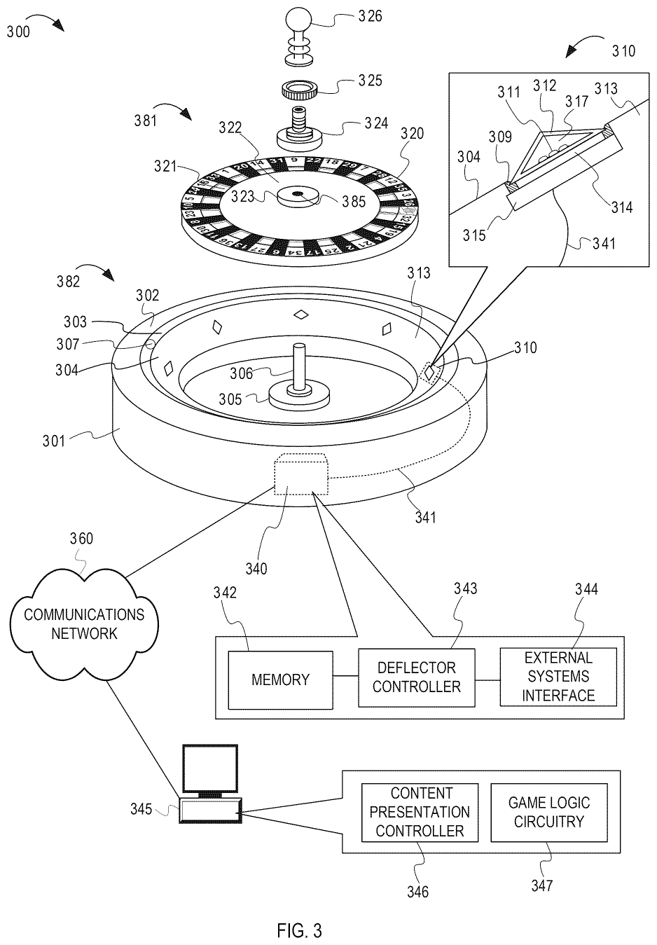

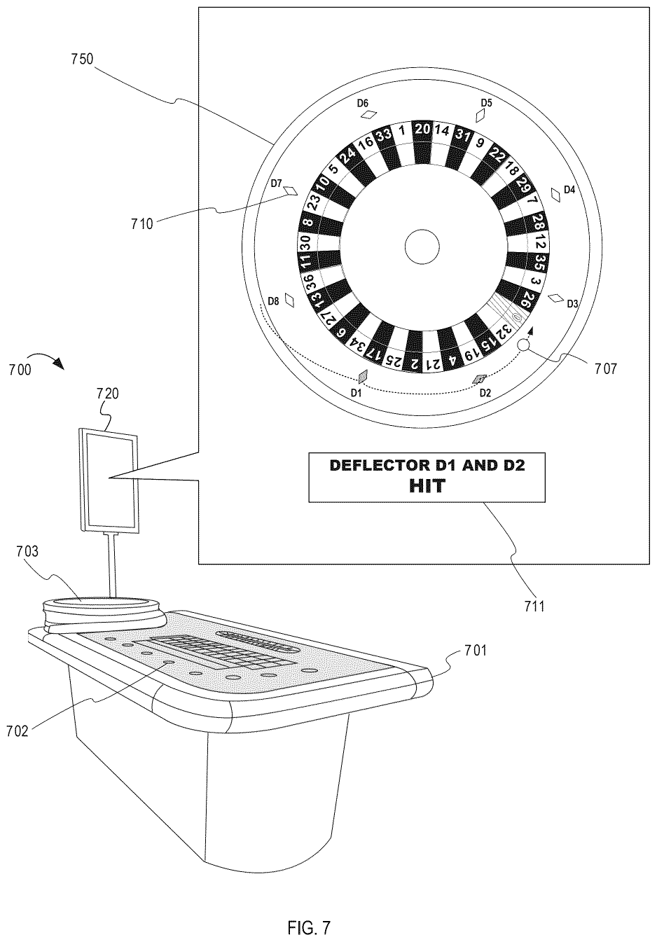

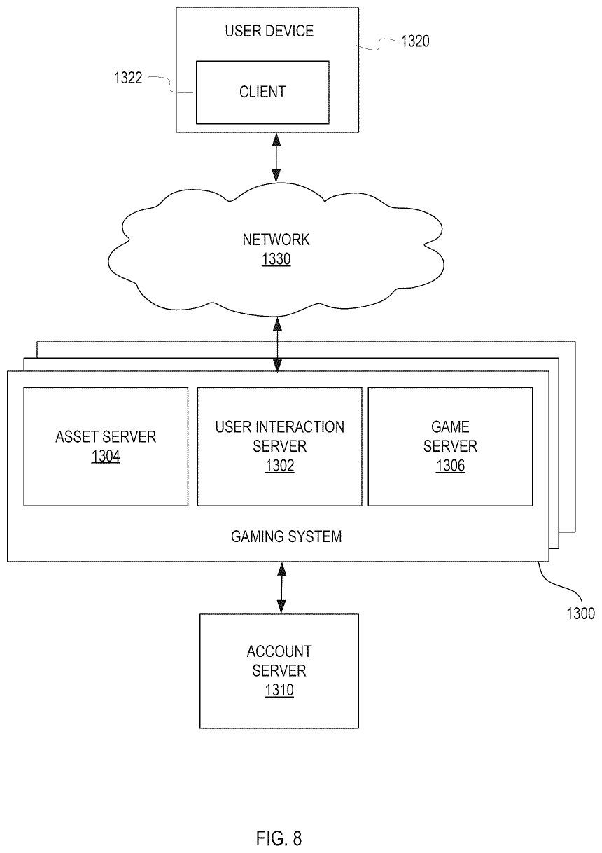

Still referring to FIG. 1, a communication device 199 may be included and operably coupled to the control processor 197 such that information related to operation of the gaming system 100, information related to the game play, or combinations thereof may be communicated between the gaming system 100 and other devices (not shown) through a suitable communication media, such, as, for example, wired networks, Wi-Fi networks, and cellular communication networks. In some embodiments, the communication device 199 is, or is associated with, switch 220 of FIG. 2, external systems interface 344 of FIG. 3, network 1330 of FIG. 7, or network adapter 1456 of FIG. 8.

Referring still to FIG. 1, the video device 158 may further include one or more banners 155 configured to communicate rules of play and/or the like, which may be located along one or more walls of the cabinet 162 or otherwise incorporated into the video device 158. The video device 158 may further include additional decorative lights (e.g., emotive lighting 170) and speakers (not shown). In some embodiments, the processor animates highlight effects with the decorative lights. For instance, the processor can select a color for the decorative lights that matches (e.g., an attribute or characteristic of) a highlight effect.

Further detail of an example of a table and/or gaming system and player displays is disclosed in U.S. patent application Ser. No. 10/764,995, filed Jan. 26, 2004, published as United States Patent Application Publication No. 2005/0164762 on Jul. 28, 2005, now U.S. Pat. No. 8,272,958, issued Sep. 25, 2012, and titled “AUTOMATED MULTIPLAYER GAME TABLE WITH UNIQUE IMAGE FEED OF DEALER,” the disclosure of each of which application and patent is incorporated herein in its entirety by this reference. Although an embodiment is described showing individual discrete player terminals, in some embodiments, the entire playing surface (e.g., player interface areas 132A through 132E, roulette wheel screen 164, etc.) may be an electronic display that is logically partitioned to permit game play from a plurality of players for receiving inputs from, and displaying game information to, the players, the dealer, or both.

In some embodiments, the gaming system 100 is configured to present (e.g., in association with the virtual roulette wheel 150, on a betting layout presented via one of player terminals 114A-114E, etc.) one or more highlight effects associated with tracked data (e.g., tracked game statistics, tracked occurrences of events over a period or range, etc.). For example, in one embodiment, the gaming system 100 provides game features associated with any of a set of deflectors (e.g., deflectors 110) positioned within a ball track of a roulette wheel (e.g., of roulette wheel 150). For example, in one instance, the gaming system 100 detects, in response to user input prior to initiation of a roulette game associated with roulette wheel 150 (e.g., during a betting period prior to release of a roulette ball), a placement of one more gaming tokens on a section of a roulette game betting layout (or via a separate playing layout) associated with one or more of deflectors 110. After initiating the roulette game (e.g., after release of the ball), the gaming system can detect, via a sensor associated with the at least one deflectors 110 while the ball traverses a ball track, an interaction event (e.g., the roulette ball hits the deflector, the ball passes within a given distance of the deflector, the ball intersects with a section of the ball track surrounding or otherwise associated with the deflector, etc.). The gaming system 100 can further animate (e.g., generate and display), in response to detecting the interaction event, a highlight effect in connection with presentation of a portion of the roulette game by the gaming system 100. The interaction event contributes to a game outcome associated with the deflectors 110. The game outcome can be independent of any game outcome for the main roulette game. Thus, in at least one embodiment, the gaming system 100 provides a secondary or complimentary physical device outcome that can run in parallel with the main roulette game which can be linked in any number of ways (e.g. secondary game, modifier to base game, etc.). The secondary outcome associated with the deflectors 110 can be independent from the actual ball outcome in the roulette game (different from the pocket, or other numbered-segment, outcome). For example, random interaction events (e.g., deflector interaction events and/or other random deflector-game results) can be determined using a random number generator (RNG) (e.g., for random selection of specific ones of a set of deflectors to assign a given color, for random selection of which deflectors or deflector regions to assign a given enhancer, for random selection of which deflectors, or how many deflectors, are required to be interacted with to achieve a random bonus, for random selection of which deflector regions to present and/or where to randomly place them on a ball track, for random selection of a ball path and given deflector interactions that occur as the ball follows the ball path to a randomly determined numbered segment, etc.). In one embodiment, such as in the example of an electronic table game system which presents a virtual roulette wheel and uses a random number generator (RNG) to generate a virtual roulette game outcome, the RNG for the roulette game outcome can be independent from the RNG of the interaction-related events (e.g., the deflector interaction events). For instance, the RNG for a deflector game can produce different random events, outcomes, etc. based on different game conditions and/or different game instructions, than an RNG for the roulette game would produce. In another embodiment, the random events, outcomes, etc. for the roulette game and the random events, outcomes, etc. for the deflector game may be based on a single RNG, which ties the deflector game outcome to the roulette game outcome.

FIG. 2 is a schematic block diagram of a gaming system architecture (“architecture 200”) according to at least some aspects of the disclosed concepts. The architecture 200 includes a plurality of player terminals 202 communicatively coupled via a network communication device (e.g., switch 220) to a virtual croupier display 222. The virtual croupier display 222 presents instructions from a virtual croupier for a group roulette game (e.g., as presented by video device 158 in FIG. 1). The virtual croupier display 222 is controlled by a display control 212 associated with one of the player terminals 202. The display control 212 is configured to present a roulette wheel (e.g., the display control 212 animates the roulette wheel 150 (see FIG. 1)) via the virtual croupier display 222. Furthermore, a game engine (also referred to as game controller 210), is associated with a different one of the player terminals 202. The game controller 210 executes roulette-outcome logic, resets won progressive values, and contains one or more random number generators (RNG(s)).

Each of the player terminals 202 includes a game client 206 that subscribes to a game service 204 associated with the roulette game. Each of the game clients 206 is configured to present game content (e.g., game assets for betting layouts, roulette wheels, highlight effects, etc.). In some embodiments, the game clients 206 are configured to present game content and highlight effects via player interface areas 132A through 132E (shown in FIG. 1). In some embodiments, the game clients 206 are configured to present game content via user interfaces (e.g., see user interface 512 in FIG. 5). Furthermore, in some embodiments, the game service 204 is associated with the game controller 210 and/or a game server (e.g., game server 1306 described for FIG. 8).

FIG. 3 is an exploded-view diagram of an example roulette wheel 300 according to at least some aspects of the disclosed concepts. Referring to FIG. 3, the roulette wheel 300 includes a first portion 381 that is configured to spin and a second portion 382 that is configured to be stationary (and upon which the first portion 381 rests and/or spins). The first portion 381 includes a wheel head 320 (or rotor) which includes a cone 322 and numbered pockets 321 that a roulette ball (ball 307) can fall into during a roulette game. The wheel head 320 is configured to spin around a spindle 306 (or shaft). The spindle 306 is part of the second portion 382 of the wheel 300. The spindle 306 enters through a hole 385 in the wheel head 320 that goes through the cone 322 and through an upper bearing 323 upon which turret 326 rests and to which the wheel head 320 is attached (via turret base 325 and height adjuster 324). The height adjuster 324 adjusts the height of the wheel head 320 relative to features of bowl 301.

The second portion 382 includes the bowl 301 (also referred to as a base). The spindle 306 is attached to the bowl 301 via a lower bearing 305. The bowl 301 contains a ball track (a track upon which the ball 307 travels as it follows a ball path toward the numbered pockets 321). The ball track includes an upper ball track portion 303 that is adjacent to a bowl rim 302, and a lower ball track portion 304 (an apron) below the upper ball track portion 303. The upper ball track portion 303 has a slight downward slope relative to a lower ball track portion 304 which has a sharper slope. The lower ball track portion 304 includes one or more deflectors 310. The deflectors 310 are configured to protrude from a wall (e.g., wall 313) of the lower ball track portion 304 so as to potentially interact with the ball 307 as the ball traverses a ball path through the lower ball track portion 304. In some embodiments herein, the deflectors 310 may be referred to as interactive deflectors (e.g., respond to an interaction with the ball 307) and/or sensing deflectors (e.g., sense a touch of, or relative location to, the ball 307).

During operation of the roulette wheel 300, the ball 307 is released into the upper ball track portion 303. For example, the ball 307 is released at a given velocity that maintains the ball 307 within the upper ball track portion 303 for a given number of revolutions around the upper ball track portion 303. When the movement of the ball 307 reduces to a certain speed it falls from the upper ball track portion 303 into the lower ball track portion 303 where it can interact with any of the deflectors 310 (or with none of the deflectors 310 depending on the actual ball path) before falling into one of the numbered pockets 321 of the wheel head 320 as the wheel head 320 spins (e.g., in an opposite direction of movement of the ball 307). As shown, the deflectors 310 are placed both horizontally and vertically around the ball track (or in some other relative configuration, such as partially vertical and/or partially horizontal). In one embodiment, half of the deflectors 310 are positioned vertically and the other half of the deflectors 310 are positioned horizontally (or in some other relative difference of orientation, such as half oriented at a first angle and half oriented at a second angle different from the first angle). The deflectors 310 as shown are diamond-shaped, however any of the deflectors 310 can take one of many different configurations (e.g., rounded, circular, etc.). It should be noted that the example shown in FIG. 3 is only one example of a roulette wheel (associated with a roulette gaming system or other such gaming system), and other embodiments include variations of the wheel design. For example, numbered pockets 321 may instead be referred to as numbered segments, which may include, but are not limited to, pockets, holes, channels, magnetic devices (e.g., to capture a metallic ball), etc., or any other mechanism for capturing or holding a ball in a final resting position within, or in relation to, the numbered segment. Furthermore, in some embodiments, numbered segments may include indicia other than numbers (e.g., distinct symbols on the wheel instead of numbers).

FIG. 3 also illustrates a cutaway-view of the deflector 310 showing a position of the deflector 310 relative to (e.g., affixed or attached relative to) wall 313 of the lower ball track portion 304. In one embodiment, the deflector 310 includes a cover 312 made of a transparent or translucent material. The material of the cover can be a durable plastic that is resistant to breakage from ball interactions. Encased within the cover 312 (e.g., inside area 317) are one or more lighting devices (e.g., lighting device(s) 311), such as programmable light-emitting diodes (LEDs) (e.g., red, green, and blue LEDs). In one embodiment, the cover 312 diffuses the light produced by the lighting device(s) 311. In some embodiments, the deflector 310 includes one or more sensors or a set of various types of sensors (e.g., sensor(s) 314). The sensor(s) 314 and lighting device(s) 311 are connected to a circuit board 315, which is connected, by a wire 341, to a control device 340.

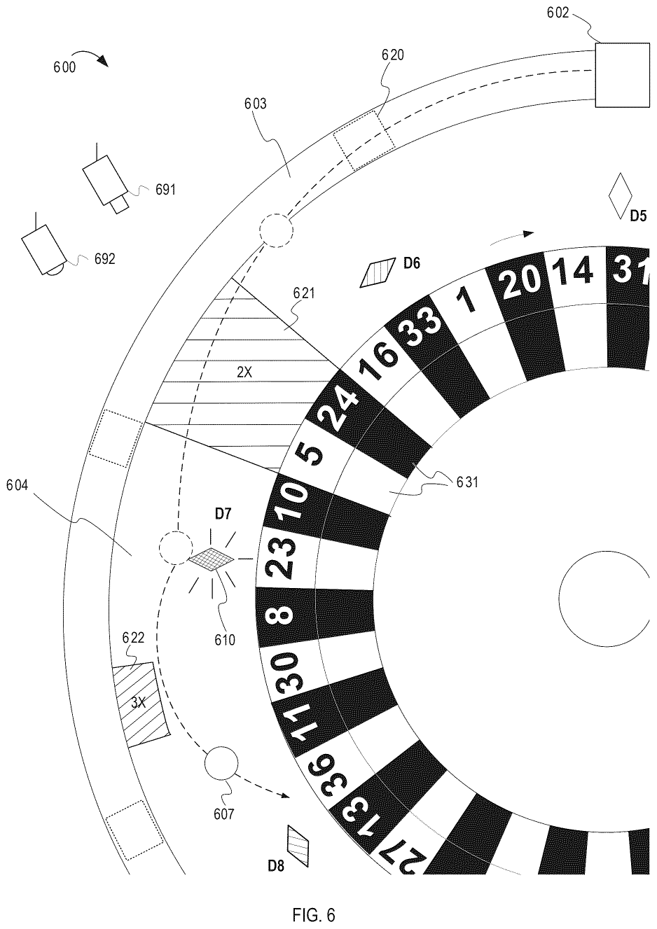

In some embodiments, the sensor 314 is equipped or configured to recognize a deflector interaction (e.g., a ball-to-deflector interaction, such as a touch event, a proximity event, etc.). In one embodiment, the sensor(s) 314 include a touch sensor, such as a switch contact sensor, an optical contact sensor, etc. In one embodiment, the deflector 310 is attached to the ball track wall 313 in a way to allow for some give, or space 309 (e.g., between the deflector 310 and wall 313), to allow for movement associated with a touch sensor activation mechanism in a variety of directions. In one embodiment, the space 309 is filled or covered with a flexible or elastic material (e.g., rubber, elastomer, etc.) to allow for a slight movement or the deflector 310, yet prevent debris from settling into the space 309, as well as to close up a sufficient portion of the space 309 to ensure a smooth path of the ball 307 as it rolls down the slope of the wall 313 and makes contact with the cover 312. In one embodiment, sensor(s) 314 include a proximity sensor, such as an infrared (IR) proximity sensor which works by sending out an infrared beam and detecting when it is interrupted by the ball 307 passing by, effectively indicating a presence of the ball 307 at a specific location on the ball track. In yet other embodiments, an external sensor can be associated with the deflectors 310 (e.g., a sensor not attached to any of the deflectors, such as an image sensor positioned relative to the deflectors 310, a proximity sensor positioned relative to a respective one of the deflectors 310, etc.). For example, as illustrated in FIG. 6, an image sensor associated with an overhead camera 691 can detect a position of a ball 607 relative to any of deflectors 610 and/or relative to one or more other wheel features (e.g., relative to upper ball track portion 603, relative to lower ball track portion 604, etc.). In another example, additional proximity sensors 620 can be positioned in other portions of the ball track, such as in the upper ball track portion 603. The roulette wheel 300 (and/or other roulette wheels described herein, such as roulette wheel 600) can include a combination of sensors (e.g., touch and/or proximity sensors in combination with image sensors).

Referring still to FIG. 3, in one embodiment, control device 340 is embedded within the bowl 301. Additional wires (not shown) can be attached to all deflectors 310 that are positioned around the lower ball track portion 304 to connect to the control device 340. In other embodiments, the deflectors 310 may communicate wirelessly to the control device 340. In some embodiments, the control device 340 can be positioned outside of the bowl 301. In one embodiment, the control device 340 includes a memory 342 (e.g., to store a current state of any of deflectors 310, to store instructions associated with deflectors 310, etc.) and a deflector controller 344 (e.g., to control and/or coordinate operations associated with interaction events, lighting effects, timing, sensing, etc. of the deflectors 310. The control device 340 also includes an external systems interface 344 to communicatively connect to a computer system 345 via a communications network 360. The computer system 345 can include a content presentation controller 346 to control content presentations associated with the deflectors 310 (e.g., lighting shows, deflector effects, etc.) as well as game logic circuitry 347 (e.g., associated with rules for the roulette game as well as rules for any games or operations associated with deflectors 310). In some embodiments, the control device 340 controls the state of the deflectors 310 (and/or associated devices) and tracks a history deflector-related interaction events (e.g., for historical outcome data, for persisted game data, etc.).

In some embodiments, additional elements or components (e.g., electrical, mechanical, some combination, etc.) can be incorporated into the deflectors 310 to cause a change in physical states, such as a height, orientation, rotation, movement, etc. of the deflectors 310. For example, the deflectors 310 can include actuators, springs, etc. that cause movement, such as a bumper action that adds or imparts additional energy to the ball 307, such as via a pushing effect that can add momentum and/or can forcefully, yet randomly, alter the trajectory of the ball beyond the mere effect of the force of gravity upon the ball 307 (caused by the falling of the ball 307 along the slope of the lower ball track portion 304).

In some embodiments, the control device 340 is configured to automatically alter or adjust the dimensions or settings associated with physical characteristics of the roulette wheel 300, such as to change a degree of slope of the ball track, raise up or lower a specific number of deflectors 310, change the height or placement of deflectors 310, modify a length of a deflectors 310, activate devices to add speed to the ball while in the ball track on the wheel rim, etc.) to cause different amounts or types of interaction events. In one example, the control device 340 can perform automatic wheel adjustments if a bias in interaction events is noticed over time regarding certain deflector interaction events. For example, the deflector controller 343 can automatically track deflector interaction events and outcome events over time and can, based on analysis of the history of the events, detect the bias, which may be related to an unlevel wheel condition or other non-optimal wheel condition. The control device 340 can either automatically correct the wheel condition (e.g., via automatically leveling mechanism using gyroscope, bullseye leveler, etc.) and/or can generate an alert to an operator to schedule a manual re-calibration or adjustment procedure for the wheel.

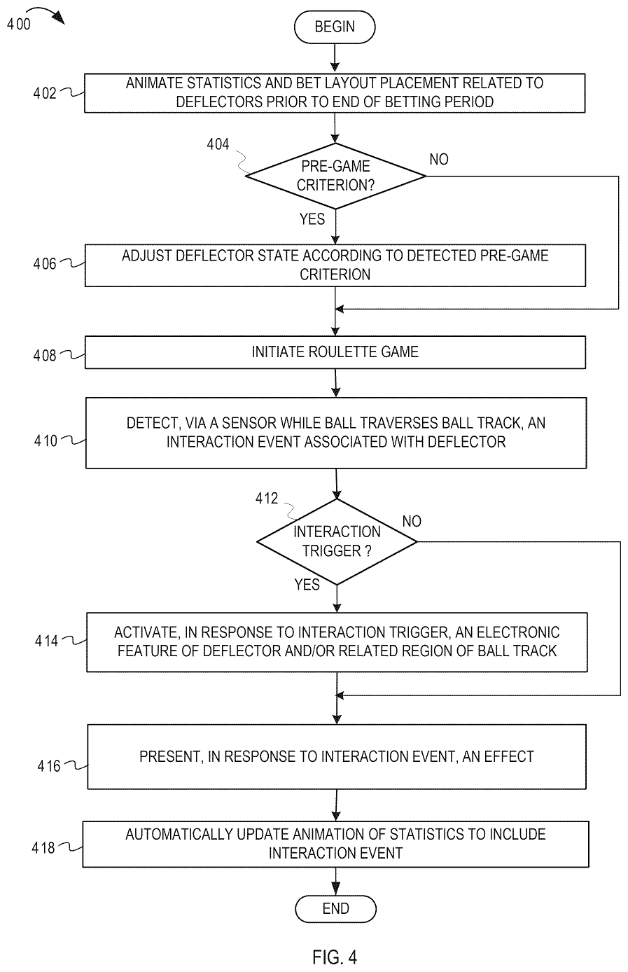

FIG. 4 is a flowchart of a flow (400) for controlling roulette interactive deflector features according to at least some aspects of the disclosed concepts. FIG. 5, FIG. 6, and FIG. 7 are diagrams of controlling roulette interactive deflector features according to at least some aspects of the disclosed concepts. FIG. 1, FIG. 2, FIG. 3, FIG. 5, FIG. 6, and FIG. 7 will be referred to concurrently with the description of the flow 400. It should be noted that while some embodiments disclosed mention one or more devices that perform an action, the processor that performs the action may involve one of one or more processors that are available by a roulette gaming system (e.g., electronic roulette system, physical-table roulette system, a hybrid roulette system with electronic and physical components, etc.) and/or distributed across a gaming network. Furthermore, it should be noted that, according to some embodiments, variations of gaming systems described herein involve any type of gaming system having a ball (e.g., standard roulette ball, metallic ball, specialized electronic ball, etc.) that traverses a ball track along which are portions (e.g., obstacles, objects, sections, features, etc.) which can experience an interaction event with the ball prior to the ball settling into a final position (e.g., prior to settling into, or being associated with, a numbered wheel segment or other such final resting location).

Referring to FIG. 4, the flow 400 starts at processing block 402, where a processor animates statistics and bet layout placement related to deflectors prior to end of a betting period for a roulette game. For example, the processor can detect placement of gaming chips on a betting layout (e.g., via detection of user-input via a graphical user interface (GUI) of a player terminal betting layout, via detection by an image sensor associated with a physical gaming table layout, etc.), which placement of gaming chips is related to a particular deflector. The processor can further animate, via a display of the roulette gaming system, a highlight effect related to the placement. For example, referring to FIG. 5, roulette gaming system 500 includes a display 560 that presents an image of a roulette wheel 550, as well as other information related to tracked data, such as roulette game statistics (e.g., statistics graphics 490), which illustrate specific statistics related to certain roulette game outcomes for a range of game play (e.g., for the last N number of roulette games played) via the gaming system 500. The other information can also include statistics 592 related to deflectors (e.g., statistics of a history of interaction events that occur over range (e.g., over the last N number of roulette games played)). In some embodiments, the display 560 is attached to a player terminal (e.g., a display associated with any player interface area 132A-132E of any active one of the player terminals 114A-114E) and/or is separate from a player terminal (e.g., screen 160 described in FIG. 1). In one embodiment (not illustrated) the display 560 can include a user-input control (e.g., a slider) which selects a range for the N value (e.g., to specify the last N number of games of the roulette wheel associated with the tracked statistics). In some embodiments, the roulette gaming system 500 is configured to present (e.g., via statistics 592) a history of occurrence of interactions events while a roulette ball traverses a ball track (e.g., present a history of which deflectors are hit most, which colors of deflectors occur most, what average amount of deflectors are hit per game, etc.). Any of the listed statistics 590 and/or 592 can be associated with a particular type of bet that can be made on the betting layout. For example, as shown in FIG. 5, the roulette gaming system 500 presents a betting layout 501 at an active player terminal. The player terminal includes at least user interface 512. In one embodiment (as shown in FIG. 5) the player terminal can also include the display 560 and/or, in another embodiment, the display 560 may be presented on a communal display for the roulette gaming system 500. On the user interface 512 are controls, settings, objects, etc. that a player interacts with during a game of roulette. The user interface 512 includes the betting layout 501 for placement of one or more virtual tokens (e.g., to place one or more bets). In one example, the user interface 512 includes a plurality of different virtual tokens of differing denomination values (e.g., a token 511 worth $1, a token 513 worth $10, etc.). While only some denomination values are shown, other denomination values may be included (e.g., 15, 20, 25, 50, 100, etc.). In some embodiments, the other virtual tokens may be accessible via a user-interface object (e.g., via scroll control). In other embodiments, the ranges of denomination values may be automatically set based on other game factors, such as for a betting level or tier associated with a game element (e.g., a pocket, a deflector, etc.), an enhancer, a modifier, etc. A detailed description of how betting levels or tiers are associated with multiplier ranges can be found in the Ser. No. 17/948,755 application and/or the Ser. No. 17/948,633 application referenced previously.

In one embodiment, instead of animating options for placement on a graphical user interface (as illustrated in FIG. 5), a roulette gaming system 700 (as illustrated in FIG. 7) that includes a physical gaming table (e.g., table 701) can present an image of information associated with one or more deflectors 710 onto a physical betting layout 702, such as via projection of content onto a felt covering or via backlighting from underneath the felt covering. The roulette gaming system 700 also includes a roulette wheel apparatus 703, which can include a physical roulette wheel (e.g., roulette wheel 300) or a virtual roulette wheel (e.g., roulette wheel 550). The roulette gaming system 700 can automatically detect an outcome that occurs from a game of roulette wheel associated with the roulette wheel apparatus 703 and can present a virtual version of the roulette wheel via a display 720 (e.g., virtual roulette wheel 750 presented via display 720) showing an outcome of a roulette game as well showing indicators of interaction events (e.g., deflector interaction animations, deflector activations, deflector state changes, etc.) associated with one or more of the deflectors 710 (e.g., identified via deflector identifiers or labels “D1” through “D8”) or with other parts of a ball track as a ball 707 traverses a ball path during a roulette game. In one embodiment, the roulette gaming system 700 presents, as one of the indicators of interaction events, a message that includes which of the deflectors 710 (e.g., which of deflector identifiers “D1” through “D8”) experienced a deflector interaction event.

Referring back to FIG. 5, in some embodiments, the roulette gaming system 500 animates (e.g., within sections 581 and 582) betting spots 531, 532, 533, 534, 535, 536, 537, and 538 (i.e., “betting spots 531-538”) that identify deflector identifiers and/or other classifications of deflectors. For example, section 581 includes labels or identifiers (e.g., “D1,” “D2,” “D3,” “D4,” “D5,” “D6,” “D7,” and “D8”) that identify the set of deflectors 510 associated with roulette wheel 550. The betting spots 531-538 may also be referred to as placement spots, which are configured for placement of virtual tokens for making a game prediction (e.g., a bet) on whether an interaction event will occur for any one (or grouping) of the deflectors 510. Various types of bets can be made, such as a single-value bet type or a multi-value bet type. A single-value bet type includes a bet on an individual (single) value associated with the betting layout 400, such as a “straight up” bet that any one of the deflectors 510 will individually experience an interaction event. A multi-value bet type involves a bet on a grouping of the deflectors 510. For example, a multi-value bet type can include a split bet, for example, where a gaming token is placed on a border between, or on connecting points of, betting spots of individual deflector values. The position of placement of the split bet thus straddles the number values on the betting layout 501 and indicates a multi-value bet on the group of deflector values that the virtual token straddles. Hence, the betting spots for split bets include the given border on which the virtual token is placed. For example, when virtual token 530 is placed on betting spot 531, a single-value bet type is placed that the deflector labeled “D1” will experience an interaction event while the ball traverses the ball path through the ball track. On the other hand, when virtual token 539 is placed on a border of adjacent betting spots (e.g., straddling betting spots 533 and 534), then a bet is placed regarding both of the deflectors 710 that are labeled “D3” and “D4” (e.g., a bet is placed that signifies that either will experience an interaction event, that each will experience an interaction event, that each will experience interaction events in succession, etc.). Section 582 includes betting spots 540 and 541 that specify other types of multi-value bet types For example, betting spot 540 is related to a multi-value bet type where a bet is placed that any evenly numbered one of the deflectors 510 (e.g., deflectors “D2,” “D4,” “D6,” or “D8”) will experience an interaction event, whereas placement spot 541 is related to a multi-value bet type where a bet is placed that an odd numbered one of the deflectors 510 (e.g., deflectors “D1,” “D3,” “D5,” or “D7”) will experience an interaction event. The odds may be different based on the differing bet types, hence different pay tables, different award outcomes, different modifiers, etc. are possible based on the different bet types placed.

In some embodiments, such as via a roulette gaming system having a physical gaming table (e.g., FIG. 7), identifiers can be projected onto betting spots where a physical chip would need to be placed for each member of subset of active or eligible ones of the deflectors 510. In other embodiments, the roulette gaming system can animate the section on a graphical user interface associated with a dealer station (e.g., a dealer display presents the betting spots and highlights the betting spots that are associated with any particular deflector) for either placement, by dealer, of virtual chips on the betting spots presented on the display (in the case of virtual chip placement) or placement, by the dealer, of physical chips on corresponding physical betting spots, for the deflectors or other relevant ball-track features, printed on a felt covering of a physical betting layout (in the case of real-world chip placement).

Some examples of possible types of bet placement options on deflectors (or other relevant ball-track features) can include, but are not limited to the following list:
(a) A bet option that the ball will interact with (or avoid interaction with) a specific deflector of the deflector set (e.g., will hit a specific identified deflector (e.g., D1), will hit a specific-colored deflector (e.g., will hit one of a subset of red colored deflectors), will avoid hitting a specific deflector, etc.).
(b) A bet option that the ball will interact with (or avoid interaction with) a certain number of deflectors (e.g., hits a specified number of deflectors to hit out of the entire set of deflectors on the wheel, avoids hitting any deflectors or avoids hitting a certain number of deflectors, etc.).
(c) A bet option that the ball will interact with (or avoid interaction with) a specific sequence of deflectors (e.g., will hit adjacent deflectors—e.g., D1 then D2 in succession, will hit non-adjacent deflectors—e.g., D1 and D3 in succession without hitting D2).
(d) A bet option that the ball will pass by or through (or avoid passing by or through) a given proximity to a given sensor or subset of deflectors (e.g., passes between two deflectors).
(e) A bet option that the ball will interact with the same deflector multiple times during the game.
(f) A bet option that the ball will follow a specific path (e.g., can be determinate on the direction that the wheel is spun).
(g) A bet option that the ball will hit specific deflectors or obtain certain deflector outcomes over a series of game cycles (e.g., bets can be based on ball interacting with a certain number of deflectors, with different types of deflectors, etc.). The deflector state can change and persist across game cycles (e.g., D1 is hit in a first game cycle and changes to a first color which persists into a second game cycle, which if hit during the second game cycle turns a second color, etc. until a given number of game cycles are completed, and deflector-game result depends on whether deflector has attained a given color by the end of the number of game cycles).
(h) etc.

Odds of occurrence of an outcome of a bet option can be based on the odds of possibility of occurrence of the particular bet-upon interaction events. More unlikely interaction events can be associated with more valuable deflector-game results. Odds of occurrence of interaction events can be based on the dimensions of a ball track. Ball tracks can be manufactured to have differing slopes, thus resulting in the ball tending to fall into a numbered segment (e.g., a pocket) faster for ball tracks having a greater slope (and hence spend less time within the ball track for interaction events). Thus, in one embodiment, the roulette gaming system automatically detects (e.g., based on a configuration setting stored in a memory of the roulette wheel, based on a machine-learning model detection, etc.) particular characteristics of the roulette wheel that may affect the odds of occurrence of the interaction events, and based on the automatic detection, modifies the game options and/or selects a different pay table for the interaction events. For example, the roulette gaming system can automatically measure and/or detect a degree of slope to the roulette wheel. In another example, the roulette gaming system automatically detects an identifier of the wheel (e.g., manufacturer of the wheel, a wheel model type or identifier, etc.) and, based on the identifier information, can adjust the odds of occurrence (e.g., selects a different pay table for the deflector bet option(s)). In some embodiments, the roulette gaming system can automatically change a slope of a ball track for a roulette wheel (e.g., the roulette wheel is manufactured to allow change to the angle of slope pre-game and/or during the game).

Interaction conditions, outcome or other events can be combined with or linked to roulette game conditions, outcomes, or other events (e.g., a secondary game bet feature that the ball will both interact with a number of deflectors and also land in a bet upon numbered segment (e.g., a wheel-value pocket) for the roulette game in order to obtain a specific game value).

In some embodiments, a specific type of bet, or a certain amount of a bet (e.g., a maximum bet value) can trigger or initiate certain features associated with interaction related conditions, events, conditions, outcomes, rewards, etc. For example, as shown in FIG. 5, a maximum bet (e.g., a placement of one or more instances 543 of virtual gaming token 513) is placed on a specific betting spot (e.g., placement of instances 543 of virtual gaming token 531 placement of maximum bets on betting spots 577 associated with separate single-value (e.g., a straight up) bets on the wheel number values “5,” and “24” respectively), which triggers a deflector enhancement for region(s) of the ball track associated with the associated wheel number value(s). For example, highlight 544 indicates that a “2× Deflector Enhancement” will be provided for interaction events associated with the region(s) associated with the wheel number values “5” and “24.” Further, as shown in FIG. 6, region 621 in lower ball track portion 604, above pockets 631 for the wheel values “5” and “24,” is highlighted to indicate that if the ball 607 interacts with (e.g., crosses over) the region 621, then a “2×” multiplier will be applied to any reward or benefit value associated with a won interaction-related bet. In one embodiment, the walls of lower ball track portion 604 can be made of a transparent material on top of which the ball 607 can travel, and under which display elements can present content (e.g., highlighting effects, colors, textures, event indicators, text, etc.) associated with the region 621. In other embodiments, a projector device 692 can project content onto the lower ball track portion 604 at the region 621. In some embodiments, the roulette gaming system 600 can provide betting options associated with specific ball track regions, such as for region 621 or for region 622 (a separate region whereby if an interaction event occurs (e.g., if ball 607 passes through region 622), then a “3×” multiplier would be applied to a reward or benefit value associated with a won interaction-related bet). In some embodiments, certain regions (e.g., regions 621 or 622) can appear randomly prior to (or during) a game and/or can include or cause different types of enhancers, modifiers, jackpot values, symbols, rewards, secondary events, etc. if an interaction event occurs with the certain regions.

Referring again to FIG. 4, the flow 400 continues at processing block 404, where the processor determines whether a pre-game criterion occurs or exists that is associated with a deflector state or that may alter a deflector state. For example, the processor determines whether any pre-game conditions or triggers have occurred (e.g., bet events, game instructions, rules, etc.) which require a pre-game deflector state adjustment. For example, pre-game triggers, conditions, or other criteria may be initiated or determined by, but are not limited to, any of the following conditions: a type of deflector presented, a type of game being selected and currently presented by the deflectors, an amount of a bet placed, a type of bet made, one or more events that occurred in previous game rounds (e.g., previous bets related to a series of game cycles, bonus events having an effect that carries over from a previous game cycle and/or which specifies a specific deflector state and/or causes a deflector state change, etc.), and so forth. In some embodiments, the pre-game condition or trigger may indicate to not perform an action that normally would be a pre-game condition (e.g., the processor persists a lit state of a deflector from a previous round by not performing a default pre-game event that would normally force the deflector to a pre-game off state).

If, at processing block 404 the processor detects that there is a pre-game criterion for a deflector state, then flow 400 continues at processing block 406, where the processor adjusts the pre-game deflector state accordingly. For example, the processor can change a power state of a deflector (e.g., turn off and/or turn on). The processor can accept certain bet placements that enable or disable certain pre-game deflector state changes, such as a player betting on a cycle of games that cause or prevent a change in color to the deflectors (e.g., color does not change for a certain number of games, index a color one step every game to move the colors around, etc.). In another example, the processor can light deflectors in a certain color to indicate a betting stage. For example, at betting time, all deflectors pulse in a first color (e.g., a green color), which means place your bets, whereas after the betting period ends, the deflectors can change to no colors or to one or more second colors (e.g., all deflectors change to a default “gold” color) based on default settings and/or based on given events (e.g., based on pre-game play effects or settings, based on bet events for current game, etc.). In other examples, the processor can cause different deflectors to be randomly assigned different colors. In another example, the processor can persist the lighting effects of certain deflectors based on events or conditions from a previous game. In another example, the processor can activate specific deflectors (e.g., turn on or off) based on betting types or values (e.g., a max bet enables all deflectors to be in play, max bet permits random selection of deflector for modifier, enhancement, etc., a bet above a first threshold activates a certain number of deflectors whereas a bet above a second threshold (higher than first) activates more of the deflectors to be in play, and so forth).

Referring again to FIG. 4, the flow 400 continues at processing block 408, where the processor initiates a game of the roulette wheel. For example, the processor can initiate the game by detecting a ball release event, such as a manual ball drop by a croupier or a ball release by a device (e.g., via ball distribution device 602 shown in FIG. 6) In some embodiments, a roulette gaming system incorporates a player interactive feature where player gets to initiate a ball release, such as by applying an amount of force, where the player gets to push a button that may cause a spring, a bumper, or other wheel component to perform a random activity, such as movement, spinning, pushing, etc., and so forth. In one embodiment, the player interactive feature involves use of a device that controls interactive function by which the player has to time their initial force of the ball based on a timing mechanism presented on a display, which timing affects the force at which the ball comes out of a ball launch mechanism (e.g., via ball distribution device 602 shown in FIG. 6). Thus, if the timing of the ball release is performed in a particular way, the greatest amount of force is applied, possibly resulting in a greater amount of time on the ball track for interaction with more deflectors or lesser amount of time on the ball track (which may correspond to a type of bet made, such as whether the ball will achieve a certain number of revolutions, whether the ball will interact or avoid interaction with a particular deflector, sensor, or other ball track feature, etc.). In some embodiments, a highest bidder (of a group of players) gets to control the speed of the launch of the ball.

Furthermore, in some embodiments, the processor can track a wheel orientation to determine whether a player bumps the wheel during the game, which may cause an automatic tilt to the game.

Referring again to FIG. 4, the flow 400 continues at processing block 410, where the processor detects, via a sensor while the ball traverses the ball track, an interaction event associated with a deflector. For example, the processor detects the interaction event based on a sensed relationship between a ball location on the ball track and a sensor location. In some embodiments, the sensor is part of the deflector, or is otherwise associated with (e.g., assigned to, linked to, etc.) a particular deflector or set of deflectors. In one example, the processor detects an interaction event in the upper ball track portion. For example, after the ball is released into upper ball track portion (e.g., upper ball track portion 303 or upper ball track portion 603), the ball moves around the upper ball track portion and then, after some movement along the upper ball track portion, falls into the lower ball track portion (e.g., lower ball track portion 304 or lower ball track portion 604). In some embodiments, for example, as shown in FIG. 6, the processor can detect interactions with sensors 620 in the upper ball track portion 603 to detect the position of the ball 607 as it goes around the upper ball track portion 603. Each of the sensors 620 may be associated with a closest one of the set of deflectors, which may then cause a highlight effect for the related deflector (e.g., the related deflector lights up up and/or pulses momentarily, thus providing a synchronized effect that shows, via the pulsed deflector lights, the relative position of the ball 607 as it goes around the upper ball track portion 603).

Another example of detecting an interaction event (or events) includes detection of an interaction event that occurs in the lower ball track portion, such as detection, during a game, whether a ball interacts (e.g., touch interactions, proximity interactions, etc.) with one of the deflectors (e.g., hits one of the deflectors, passes within a certain distance of a deflector, etc.). Another example of detecting an interaction event includes detection of whether a ball location (e.g., along a ball path) coincides with (e.g., passes through, touches, is in proximity to, etc.) any portion of the ball track (not just deflectors, but areas or sections of ball track, such as detection of whether the ball passes through a special zone on the wall of the ball track). Another example of detecting an interaction event includes detection of multiple interactions, such as a number of times the ball has interaction with a number of deflectors (e.g., to count as progress toward a given outcome). The interaction event can be a single event or sequence of events that persist or continue from previous games (e.g., if a series of interaction events, such as a certain number of deflectors are hit, over a certain time or over a period of a number of roulette games). Another example of detecting an interaction event includes detection of whether a specific ball characteristic triggers interaction tracking. For example, referring momentarily to FIG. 6, a specific colored ball, such as a gold ball, can be randomly released from ball distribution device 602, which, the roulette gaming wheel 600 detects (e.g., via detection of a signal generated by the ball distribution device 602 regarding the ball characteristic or via detection via recording and analysis of image data from the image sensor of camera 691). In one or more embodiments, the roulette gaming system 600 uses a machine learning model to analyze image data captured by the image sensor to detect specific ball characteristics, to detect ball-track features, to track and/or predict a ball path, to detect interaction events, etc. Thus, in one embodiment, in response to detection (e.g., via machine learning model analysis of the image data captured by the image sensor of camera 691) that the ball 607 is gold colored (as opposed to a standard white colored ball), the roulette gaming system 600 then begins to track any interaction events related to the ball 607 as it traverses the ball track and/or activates any deflector-related game features.

Referring again to FIG. 4, the flow 400 continues at processing block 412, where the processor determines whether the interaction event triggers a response by a deflector or a specific interaction-related region of the ball track. For example, in response to detecting an interaction event, the processor causes a state change to the deflector or the interaction-related region of the ball track. If, at processing block 412 the processor determines that the interaction event triggers a response, then, the flow 400 continues at processing block 414, where the processor activates, in response to detection of the interaction event, an electronic feature of the deflector or of the interaction-related region. For example, a deflector state-change event can include, but is not limited to, lighting (e.g., the processor lights up a deflector or interaction-related region to indicate win or progress toward a win), color changes (e.g., the processor changes the color of the deflector after being interacted with), modification to a physical property (e.g., the processor changes deflector height, width, orientation, location, rotation, etc.), directionality effects (e.g., the processor animates (e.g., generates, presents, changes, etc.) highlight effects based on a direction of the wheel and/or a detected direction, location, vector, or other characteristic of the ball), etc. In some embodiments, state change events can be associated with a game state, with a particular gaming terminal for a particular player, with a benefit (e.g., a privilege, a win, a bonus opportunity, a promotion, a status upgrade, etc.), with a non-deflector state, etc.

In some embodiments, the response of the deflector or a specific interaction-related region is associated with (e.g., causes, enables, corresponds to, etc.) occurrence of one or more secondary events. For example, the following is a non-exhaustive list of some examples of secondary events:
(a) Awarding a bonus. For example, the processor can award a free spin, trigger of a bonus ball, etc. (e.g., a bonus game or ball can be awarded in response to detection of a certain number of interactions (e.g., hits of deflectors), a certain sequence of interactions, after hitting a specific bonus deflector, after being in play on the ball track for a certain number of seconds, etc.).
(b) Generating a community game outcome. For example, each deflector can represent a different player in a community game. If the ball interacts with a specific deflector that has been associated with a particular player, then the system associates the event outcome (and/or benefit) to the particular player. In another example, a group of players may be allowed a certain number of games (tournament style) to see who gets the best score or points or value from certain interaction events or other ball-track region events. In another example, each member of a group of players has to buy a section of the wheel, and if all sections are bought up (and/or some other event occurs such as if one player wins in the base game in addition to the a detected interaction event), then the others may get a portion of the payout or share in another type of reward, such as a shared bonus. In one example, if a certain number of deflectors are hit then each person in the group who bet on an interaction event occurring may get a free game (e.g., their previous bet on the wheel number value(s) carries over into the free game).
(c) Enhancing a side-bet win. For example, a side bet win can be enhanced (e.g., doubled).
(d) Awarding a base game modifier or multiplier.
(e) Awarding a progressive jackpot. The value or typo of the progressive jackpot awarded can be based on the odds of occurrence related to the possible outcomes that could occur due to the interaction event.
(f) Increasing a game award or additional game benefit related to previous events or persisted states of a deflector or other ball-track feature. For example, a bet condition related to deflectors includes a bet that a certain number of deflectors will be hit (e.g., a bet to hit 5 of 8 deflectors) within a given number of games. For example, if any deflector is hit it lights up in a first color and remains lit for a remainder of the given number of games. Subsequently, if any one of the lit deflectors is hit again during those given number of games, the hit deflector changes to a second color, which second color persists through any remainder of the given number of games. The processor awards additional value based on the deflector having attained the second color (e.g., provides a multiplier to a game reward value, provides a game bonus, awards a progressive, adds an additional game to the given number of games, etc.).
(g) Etc.

If at processing block 412 the processor determines that the interaction event does not trigger a response, then the flow 400 continues at processing block 416, where the processor presents, in response to the interaction event, an effect. For example, in some embodiments, the processor animates, in response to the interaction event, a highlight effect in connection with presentation of at least a portion of the roulette game. In some embodiments, the effect (e.g., highlight effect) is a message or indicator specifying a value, outcome, result, value, etc. associated with occurrence of an interaction event (e.g., an interaction message, a payout indicator, a reward indicator, etc.). The effect can be associated with (e.g., performed in connection with) occurrence of the interaction event, based on the response of the deflector or a specific interaction-related region, and/or in response to a secondary event that occurs as a result (e.g., one of the secondary events mentioned previously). Furthermore, the effect can be associated with a specific bet payout as indicated on a playing terminal (e.g., in FIG. 5, the bet upon bet spots 531, 533 and/or 534 can indicate reward values, credit meter 515 increments, etc.). In addition, in some embodiments, the effect is presented in response to, or presented in connection with, activation of the electronic feature of the deflector and/or the related region of the ball track (414), such as presentation of a light effect, a vibration effect, an effect to a change in orientation, etc.

Referring again to FIG. 4, the flow 400 continues at processing block 418, where the processor automatically updates an animation of statistics for the interaction event that occurred during the game. For example, referring to FIG. 5, the statistics 592 can be updated based on the occurrence of interaction events related to a history of deflector interaction events within a range of games (or game cycles) associated with processing block 402. In some embodiments, some portions of the flow 400 described in FIG. 4 can be performed independently from a remainder of the flow 400, such as processing blocks 402 and/or 418 (or portions thereof) related to collection, analysis, and/or presentation of the statistics associated with deflectors and/or other interaction-related events. In other examples, a roulette gaming system may be configured minimally and/or may include settings that disable certain options associated with a deflector or other interactive ball track features (e.g., pre-game criterion associated with processing block 404 and/or accompanying deflector state adjustments associated with processing block 406 may be disabled in a setting, interaction triggers associated with processing block 412, and/or electronic features of the deflector and/or interaction-related region associated with processing block 414 may be disabled in a setting, tracking and animation of statistics of interaction events (e.g., in processing block 402 or processing block 415) may be disabled in a setting, etc.).

FIG. 8 is a schematic block diagram of a gaming system 1300 for implementing wagering games and interaction events according to an embodiment of the present disclosure. The gaming system 1300 enables end users to access proprietary and/or non-proprietary game content through an online casino client 1322 (“the client 1322”). Such game content may include, without limitation, various types of wagering games such as card games, dice games, big wheel games, roulette, scratch off games (“scratchers”), and any other wagering game where the game outcome is determined, in whole or in part, by one or more random events.

The client 1322 may be an online casino that handles user funds and enables play of a wide variety of casino-style games, such as roulette, card games, dice games, slot games, and electronic gaming machine (EGM) games. A player accesses the client 1322 with a user device 1320 such as a personal computer, tablet, cell phone or other mobile device over a network, such as the internet or a closed casino network. Players are able to make real money wagers through the user device 1320 and the client 1322 delivers game results to the player over a network (not shown). Losses are taken by the online casino, and wins are paid out to the player. The client 1322 handles client funds and interacts with financial service providers to transfer funds in and out of the casino accounts. The server architecture of the client 1322 can take many forms. In one example, the client 1322 is operably connected to a separate remote gaming system 1300 that administers and delivers game results for one or more games and/or options associated with interaction events, but in other embodiments, all of the online game play is administered in the client 1322. Exemplary gaming system 1300 delivers game results, administers game rules, and confirms wagers are made and that funds are available, but such system does not interact directly with users and does not handle player funds.

The wagering games supported by the gaming system 1300 may track player account balances and may use this information to confirm a game result can be delivered. The same system could be used to administer play-for-fun games in which account balances are tracked but do not represent real currency.

A virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in a game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 1300 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 1300 may include a gaming platform that establishes a portal for an end user to access via a user device 1320 to a wagering game hosted by a game server 1306 through a user interaction server 1302. The user device 1320 may communicate with user interaction server 1302 using a network 1330 (e.g., the Internet). The user interaction server 1302 may communicate with the game server 1306 and provide game information, such as graphical displays and game interactions to the user. In some embodiments, the functionality of the gaming system 1300 may be incorporated into the online casino client 1322. In some embodiments, the user device 1320 communicates with a game provided by the game server 1306, while other embodiments may include a plurality of user devices 1320 configured to communicate and provide end users with access to the same game provided by the game server 1306. In addition, a plurality of end users may be permitted to access a single user interaction server 1302, or a plurality of user interaction servers 1302, to access the game server 1306.

The user interaction server 1302 may communicate with the user device 1320 through the client 1322 to enable access to the gaming system 1300. The user may be unaware that the game is being administered by gaming system 1300 and not the client 1322. In some embodiments, the user device 1320 includes a user display that includes game assets delivered from the asset server 1304 from gaming system 1300, as well as casino assets (such as the casino name, logo and other distinctive graphics) delivered by the client 1322. The user interaction server 1302 may enable a user to create and access a user account and interact with gaming server 1306. The user interaction server 1302 may enable users to initiate new games, join existing games, and interface with games being played by the user.

In some embodiments, the user interaction server 1302 may also provide the client 1322 for execution on the user device 1320 for accessing the gaming system 1300. The client 1322 provided by the gaming system 1300 for execution on the user device 1320 can comprise a variety of implementations according to the user device 1320 and method of communication with the gaming system 1300. In one embodiment, the user device 1320 connects to the gaming system 1300 using a web browser, and the client 1322 executes within a browser window or frame of the web browser. In another embodiment, the client 1322 is a stand-alone executable on the user device 1320.

In one embodiment, the client 1322 may comprise a relatively small amount of script (e.g., JAVASCRIPT®), also referred to as a “script driver,” including scripting language that controls an interface of the client 1322. The script driver may include simple function calls requesting information from the gaming system 1300. In other words, the script driver stored in the client 1322 may merely include calls to functions that are externally defined by, and executed by, the gaming system 1300. As a result, the client 1322 may be characterized as a “thin client.” As that term is used herein, the client 1322 may be little more than a script player. The client 1322 may simply send requests to the gaming system 1300 rather than performing logic itself for the games administered by gaming system 1300. The client 1322 may perform logic for other games that are not administered by gaming system 1300. For example, gaming system 1300 may administer an online casino's card games while all other games are administered by the client 1322. The client 1322 receives player inputs, and the player inputs are passed to the gaming system 1300 for processing and executing the wagering game. In one embodiment, this includes providing specific graphical display information to the client 1322 as well as game outcomes.

In other embodiments, the client 1322 comprises an executable file rather than a script. In that case, the client 1322 may do more local processing than does a script driver, such as calculating where to show what game symbols upon receiving a game outcome from game server 1306 through user interaction server 1302. In one embodiment, it may be that portions of an asset server 1304 are loaded onto the client 1322 and are used by the client 1322 in processing and updating graphical displays. Due to security and integrity concerns, some embodiments will have the bulk of the processing of the game play performed in the gaming system 1300. However, some embodiments may include significant game processing by the client 1322 when the client and user device 1320 are considered trustworthy or when there is reduced concern for security and integrity in the displayed game outcome. In most embodiments, it is expected that some form of data protection, such as end-to-end encryption, will be used when data is transported over network 1330. Network 1330 may be any network, including, but not limited to, the Internet, a communications network, a cell-phone network, a mobile device network, a wireless network, etc.

In an embodiment where the client 1322 implements further logic and game control methodology beyond the thin client, the client 1322 may parse and define player interactions prior to passing the player interactions to the gaming system 1300. Likewise, when the client 1322 receives a gaming interaction from the gaming system 1300, the client 1322 may be configured to determine how to modify the display as a result of the gaming interaction. The client 1322 may also allow the player to change a perspective or otherwise interact with elements of the display that do not change aspects of the game.

The gaming system 1300 may include the asset server 1304, which may host various media assets (e.g., audio, video, and image files) that may be sent to the client 1322 for presenting the various wagering games to the end user. In other words, in this embodiment, the assets presented to the end user may be stored separately from the client 1322. In one embodiment, the client 1322 requests the assets appropriate for the game played by the user; in other embodiments, especially those using thin clients, just those assets that are needed for a particular display event will be sent by game server 1306 when the game server 1306 determines they are needed, including as few as one asset. In one example, the client 1322 may call a function defined at the user interaction server 1302 or asset server 1304, which may determine which assets are to be delivered to the client 1322 as well as how the assets are to be presented by the client 1322 to the end user. Different assets may correspond to the various clients that may have access to the game server 1306 or to different games to be played.

The game server 1306 is configured to perform game play methods and determine game play outcomes that are provided to the user interaction server 1302 to be transmitted to the user device 1320 for display on the end user's computer. For example, the game server 1306 may include game rules for one or more wagering games, such that the game server 1306 controls some or all of the game flow for a selected wagering game as well as the determined game outcomes. The game server 1306 may include pay tables and other game logic. The game server 1306 also performs random number generation for determining random game elements of the wagering game. In one embodiment, the game server 1306 is separated from the user interaction server 1302 by a firewall or other method of preventing unauthorized access to the game server 1306 from the general members of the network 1330.

The user device 1320 may present a gaming interface to the player and communicate the user interaction to the gaming system 1300. The user device 1320 may be any electronic system capable of displaying gaming information, receiving user input, and communicating the user input to the gaming system 1300. As such, the user device 1320 can be a desktop computer, a laptop, a tablet computer, a set-top box, a mobile device (including, but not limited to, a smartphone), a kiosk, a terminal, or another computing device. The user device 1320 operating the client 1322 may comprise an interactive electronic gaming system, such as the gaming system 100 (see FIG. 1). The client 1322 may be a specialized application or may be executed within a generalized application capable of interpreting instructions from an interactive gaming system, such as a web browser.

The client 1322 may interface with an end user through a web page or an application that runs on a device including, but not limited to, a smartphone, a tablet, or a general computer, or the client 1322 may be any other computer program configurable to access the gaming system 1300. The client 1322 may be illustrated within a casino webpage (or another interface) indicating that the client 1322 is embedded into a webpage, which is supported by a web browser executing on the user device 1320.

In one embodiment, the gaming system 1300 may be operated by a different entity than the operator of the client 1322. The hardware of gaming system 1300 may be located remotely from the client 1322. The user device 1320 may be operated by a third party, such as a casino or an individual, that links to the gaming system 1300, which may be operated, for example, by a wagering game service provider. Therefore, in some embodiments, the user device 1320 and the client 1322 may be operated by a different administrator than the operator of the game server 1306, and the user device 1320 and the client 1322 may also be operated by separate administrators. In other words, the user device 1320 may be part of a third-party system that does not administer or otherwise control the gaming system 1300 or game server 1306.

In another embodiment, the user interaction server 1302 and asset server 1304 are provided by a third-party system. For example, a gaming entity (e.g., a casino) may operate the user interaction server 1302 or user device 1320 to provide its customers access to game content managed by a different entity that may control game server 1306, amongst other functionalities. In some embodiments, these functions are operated by the same administrator. For example, a gaming entity (e.g., a casino) may elect to perform each of these functions in-house, such as providing both the access to the user device 1320 and the actual game content and providing administration of the gaming system 1300.

The gaming system 1300 may communicate with one or more external account servers 1310, optionally through another firewall. For example, the gaming system 1300 itself may not directly accept wagers or issue payouts. That is, the gaming system 1300 may facilitate online casino gaming but may not be part of a self-contained online casino itself. Instead, the gaming system 1300 may facilitate the play of wagering games owned and controlled by a company offering games and gaming products and services, such as SHFL entertainment, Inc. Another entity (e.g., a casino or any account holder or financial system of record) may operate and maintain its external account servers 1310 to accept bets and make payout distributions. The gaming system 1300 may communicate with the account servers 1310 to verify the existence of funds for wagering and to instruct the account server 1310 to execute debits and credits.

In some embodiments, the gaming system 1300 may directly accept bets and make payout distributions, such as in the case where an administrator of the gaming system 1300 operates as the client 1322. As discussed above, the gaming system 1300 may be integrated within the operations of a casino rather than separating out functionality (e.g., game content, game play, credits, debits, etc.) among different entities. In addition, for play-for-fun wagering games, the gaming system 1300 may issue credits, take bets, and manage the balance of the credits according to the game outcomes, but the gaming system 1300 may not permit payout distributions or be linked to an account server 1310 that permits payout distributions. Such credits may be issued for free, through purchase, or for other reasons, without the ability for the player to cash out. Such play-for-fun wagering games may be administered on platforms that do not permit traditional gambling, such as to comply with jurisdictions that do not permit online gambling. In embodiments where a user device 1320 accesses games administered by gaming system 1300 through the client 1322, the account server 1310 contains “mirror accounts” that track account balances to confirm wagers have been made and there are funds to support the wagers before delivering game results. In this embodiment, no actual player funds are handled by the account server 1310.

The gaming system 1300 may be configured in many ways, from a fully integrated single system to a distributed server architecture. The asset server 1304, the user interaction server 1302, the game server 1306, and the account server 1310 may be configured as a single, integrated system of code modules running on a single server or machine, where each of the servers is functionally implemented on a single machine. In such a case, the functionality described herein may not be implemented as separate code modules. The asset server 1304, the user interaction server 1302, the game server 1306, and the account server 1310 may also be implemented as a plurality of independent servers, each using its own code modules running on a separate physical machine, and may further include one or more firewalls between selected servers (depending on security needs). Each server could communicate over some kind of networked connection, potentially as varied as that described for network 1330. Further, each single server shown in FIG. 8 may be implemented as a plurality of servers with load balancing and scalability factors built into the embodiment. All such embodiments and variations are fully contemplated.

Additional features may be supported by the game server 1306, such as hacking and cheating detection, data storage and archival, metrics generation, messages generation, output formatting for different end user devices, as well as other features and operations. For example, the gaming system 1300 may include additional features and configurations as described in U.S. patent application Ser. No. 13/353,194, filed Jan. 18, 2012, and U.S. patent application Ser. No. 13/609,031, filed Sep. 10, 2012, both titled “NETWORK GAMING ARCHITECTURE, GAMING SYSTEMS, AND RELATED METHODS,” the disclosures of which are incorporated herein in their entirety by this reference.

The network 1330 may enable communications between the user device 1320 and the gaming system 1300, and the user device 1320 and the online casino client 1322. A network may also connect the gaming system 1300 and account server 1310, and, further, one or more networks may interconnect one or more of the other servers shown collectively as the game system 1300. In one embodiment, the network 1330 uses standard communications technologies and/or protocols. Thus, the network 1330 can include links using technologies such as Ethernet, 802.11, worldwide interoperability for microwave access (WIMAX®), 3G, digital subscriber line (DSL), asynchronous transfer mode (ATM), INFINIBAND®, PCI Express Advanced Switching, etc. Similarly, the networking protocols used on the network 1330 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1330 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 1330 can include links comprising one or more networks such as the Internet.

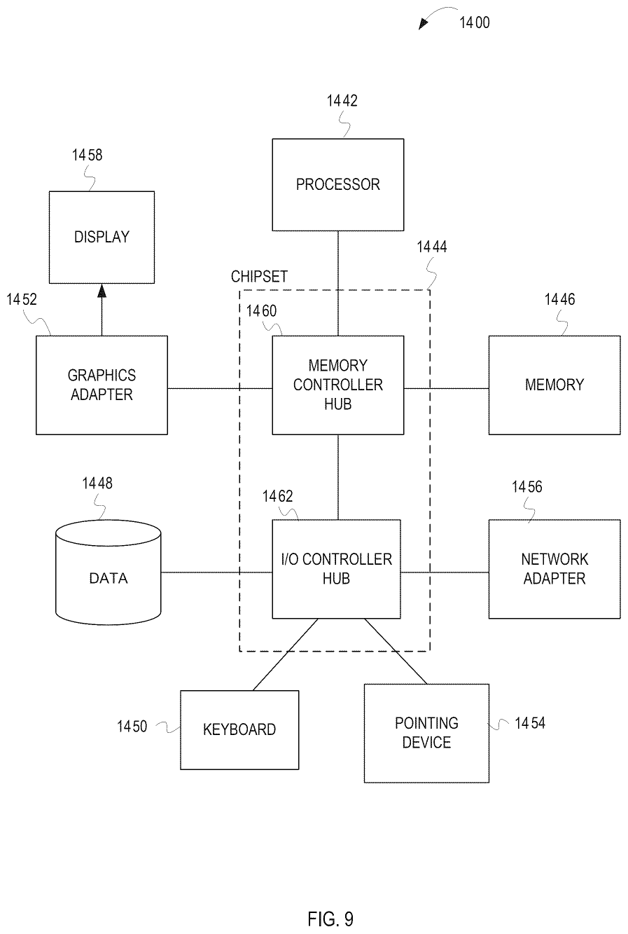

FIG. 9 is a block diagram of a computer system 1400 according to one or more embodiments. In one embodiment, the computer system 1400 can be used for acting as at least some portion of the gaming system 100 (see FIG. 1), the computer system 345 (see FIG. 3), the roulette gaming system 500, the roulette gaming system 600, the roulette gaming system 700, or the gaming system 1300 (see FIG. 8). The computer system 1400 includes at least one processor 1442 coupled to a chipset 1444, as indicated in dashed lines. Also coupled to the chipset 1444 are memory 1446, a storage device 1448, a keyboard 1450, a graphics adapter 1452, a pointing device 1454, and a network adapter 1456. A display 1458 is coupled to the graphics adapter 1452. In one embodiment, the functionality of the chipset 1444 is provided by a memory controller hub 1460 and an I/O controller hub 1462. In another embodiment, the memory 1446 is coupled directly to the processor 1442 instead of to the chipset 1444.

The storage device 1448 is any non-transitory computer-readable storage medium, such as a hard drive, a compact disc read-only memory (CD-ROM), a DVD, or a solid-state memory device (e.g., a flash drive). The memory 1446 holds instructions and data used by the processor 1442. The pointing device 1454 may be a mouse, a track pad, a track ball, or another type of pointing device, and it is used in combination with the keyboard 1450 to input data into the computer system 1400. The graphics adapter 1452 displays images and other information on the display 1458. The network adapter 1456 couples the computer system 1400 to a local or wide area network.

As is known in the art, the computer system 1400 can have different and/or other components than those shown in FIG. 9. In addition, the computer system 1400 can lack certain illustrated components. In one embodiment, the computer system 1400 acting as the gaming system 100 (FIG. 1) lacks the keyboard 1450, pointing device 1454, graphics adapter 1452, and/or display 1458. Moreover, the storage device 1448 can be local and/or remote from the computer system 1400 (such as embodied within a storage area network (SAN)). Moreover, other input devices, such as, for example, touch screens may be included.

The network adapter 1456 (may also be referred to herein as a communication device) may include one or more devices for communicating using one or more of the communication media and protocols discussed above with respect to FIG. 1.

In addition, some or all of the components of this general computer system 1400 of FIG. 9 may be used as part of the processor and memory discussed above with respect to the systems or devices described for FIG. 1, FIG. 2, FIG. 3, FIG. 5, FIG. 6 or FIG. 7.

The gaming system 100 (FIG. 1), the computer system 345 (see FIG. 3), the roulette gaming system 500, the roulette gaming system 600, the roulette gaming system 700, and/or the gaming system 1300 (FIG. 8) may comprise several such computer systems 1400. The gaming system 100 may include load balancers, firewalls, and various other components for assisting the gaming system 100 to provide services to a variety of user devices.

The computer system 1400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 1448, loaded into the memory 1446, and executed by the processor 1442.

FIG. 4, described by way of examples above, represents at least one algorithm that corresponds to at least some instructions stored and executed by the game-logic circuitry associated with any of the systems or devices described for FIG. 1, FIG. 2, FIG. 3, FIG. 5, FIG. 6, FIG. 7, or FIG. 8 to perform the above described functions associated with the disclosed concepts.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation. Features of various embodiments of the inventive subject matter described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments which are defined only by the appended claims. Further, since numerous modifications and changes may readily occur to those skilled in the art, it is not desired to limit the inventive subject matter to the exact construction and operation illustrated and described, and accordingly all suitable modifications and equivalents may be resorted to, falling within the scope of the inventive subject matter.

1. A method comprising:
detecting, by one or more processors in response to a user input via a gaming system, a placement of one or more gaming tokens on a portion of a playing layout associated with at least one deflector of a set of deflectors of a roulette wheel;
initiating, by the one or more processors, a roulette ball release for a roulette game;
detecting, by the one or more processors via a sensor while the ball traverses a ball track of the roulette wheel, an interaction event with the at least one deflector; and
presenting, by the one or more processors in response to detecting the interaction event, an effect associated with the interaction event.

2. The method of claim 1, wherein detecting the interaction event comprises detecting, by the one or more processors via the sensor, a location of the ball relative to a location of the at least one deflector.

3. The method of claim 1, wherein presenting the effect associated with the interaction event in response to detecting the interaction event includes, activating, by the one or more processors, an electronic feature of the at least one deflector.

4. The method of claim 3, wherein activating the electronic feature of the at least one deflector comprises one or more of changing a power state of the at least one deflector, activating a light of the at least one deflector, changing a color of a light presented by the at least one deflector, or modifying a physical aspect of the at least one deflector.

5. The method of claim 4, wherein modifying the physical aspect comprises modifying one or more of a deflector height, a deflector width, a deflector orientation, a deflector location, or a deflector rotation.

6. The method of claim 1, wherein presenting the effect associated with the interaction event comprises activating an electronic feature associated with a related region located on the ball track.

7. The method of claim 1, wherein random occurrence of the interaction event is independent from a random outcome of the roulette game.

8. The method of claim 1 further comprising:
tracking, by the one or more processors, outcome data for a history of interaction events that have occurred across a range of roulette games performed by the roulette gaming system; and
animating, via one or more displays associated with the roulette gaming system, statistics associated with the outcome data.

9. The method of claim 8 further comprising:
automatically updating, by the one or more processors, the outcome data in response to detecting the interaction event; and
automatically updating, by the one or more processors, an animation of the statistics associated with the outcome data.

10. The method of claim 1 further comprising:
animating, via a graphical user interface (GUI) of a display of a player terminal of the gaming system, the placement of the one more gaming tokens, wherein the one or more gaming tokens comprise one or more virtual tokens.

11. The method of claim 1, wherein placement of the one or more gaming tokens is on a betting spot of the portion of the betting layout associated with a prediction that the interaction event will occur to the at least one deflector while the ball traverses the ball track, and said method further comprising presenting the effect in connection with a reward for occurrence of the interaction event.

12. A system comprising:
a roulette wheel comprising a bowl and a wheel head, wherein the bowl includes a ball track having a set of deflectors, wherein the bowl is configured to receive a released ball, wherein the ball traverses the ball track prior to settling on a numbered segment of the wheel head;
a sensor associated with at least one deflector of the set of deflectors; and
a processor configured to execute instructions, which when executed, cause the system to perform operations to:
detect, via the sensor while the ball traverses the ball track, an interaction event associated with the at least one deflector; and
present, in response to detection of the interaction event, an effect associated with the interaction event.

13. The system of claim 12, wherein the sensor comprises at least one member of a group consisting of a touch sensor, a proximity sensor, an image sensor, a switch contact sensor, and an optical contact sensor.

14. The system of claim 12, wherein the processor is configured to execute instructions, which when executed, cause the system to perform operations to:
detect, in response to a user input prior to the roulette game, a placement of one more gaming tokens on a playing layout for a placement option associated with the at least one deflector, wherein presentation of the effect is associated with resolution of the placement.

15. The system of claim 12, wherein the processor is configured to execute instructions, which when executed, cause the system to perform further operations to activate, as the effect associated with the interaction event, an electronic feature of the at least one deflector.

16. The system of claim 15, wherein activation of the electronic feature of the at least one deflector comprises one or more of a change to a power state of the at least one deflector, operation of a light of the at least one deflector, or a change in color of a light presented by the at least one deflector.

17. The system of claim 15, wherein activation of the electronic feature of the at least one deflector comprises modification one or more of a deflector height, a deflector width, a deflector orientation, a deflector location, or a deflector rotation.

18. The system of claim 12, wherein the processor configured to present the effect associated with the interaction event is configured to execute further instructions, which when executed, cause the system to perform further operations to activate, in response to detection of the interaction event, an electronic feature associated with a region located on the ball track, wherein the region is closer to the at least one deflector than to any other ones of the set of deflectors.

19. One or more non-transitory, machine-readable mediums having instructions stored thereon, which, when executed by a set of one or more processors, cause a gaming system to perform operations comprising:
detecting, in response to a user input, a placement of one or more gaming tokens on a portion of a playing layout associated with at least one deflector of a set of deflectors of a wheel of the roulette gaming system;
initiating, after detecting the placement, a roulette game via the roulette gaming system;
detecting, while the ball traverses a ball track of the wheel, an interaction event with the at least one deflector; and
animating, via a display of the roulette gaming system in response to detecting the interaction event, a highlight effect.

20. The one or more non-transitory, machine-readable mediums of claim 19, wherein detecting the interaction event comprising generating the interaction event using a first random number generator, and wherein a random outcome for the roulette game is generated using a second random number generator independent from the first random number generator.
